(19) United States
(12) Patent Application Publication
(10) Pub. No.: US 2026/0351462 A1
(43) Pub. Date: Nov. 5, 2026

(54) MAGNETICALLY COUPLED COIL COMPONENT

(71) Applicant: TAIYO YUDEN CO., LTD., Tokyo (JP)

(72) Inventors: Yukihiro SAIDA, Tokyo (JP); Kenichiro NOGI, Tokyo (JP)

(21) Appl. No.: 19/640,672

(22) Filed: Apr. 7, 2026

(30) Foreign Application Priority Data
May 2, 2025 (JP) 2025-076941

(51) Int. Cl. H01F 27/28; H01F 27/29

(52) U.S. Cl. CPC H01F 27/2804; H01F 27/2852; H01F 27/292; H01F 27/2809

(57) ABSTRACT

Magnetically coupled coil component includes: magnetic substrate having first surface; first coil conductor including first loop part wound around coil axis extending in direction parallel with first surface, and first lead-out part connected to one end of first loop part; second coil conductor including second loop part wound around coil axis, and second lead-out part connected to one end of second loop part; first external electrode connected to first lead-out part; and second external electrode connected to second lead-out part. First lead-out part includes: first routing part extending from the one end of first loop part in direction away from second coil conductor; and first connection part connecting first routing part and first external electrode. Second lead-out part includes: second routing part extending from the one end of second loop part in direction away from first coil conductor; and second connection part connecting second routing part and second external electrode.

### CROSS-REFERENCE TO RELATED APPLICATION

The present application claims priority under 35 U.S.C. §119 to Japanese Patent Application No. 2025-076941, filed May 2, 2025, the contents of which are incorporated herein by reference in their entireties.

### BACKGROUND OF THE INVENTION

### Field of the Invention

The present disclosure relates to a magnetically coupled coil component.

### Description of the Related Art

A magnetically coupled coil component includes a set of coil conductors magnetically coupled to each other. Examples of the magnetically coupled coil component include a choke coil, a transformer, and a coupled inductor (see, for example, Japanese Patent Application Laid-Open Publication No. 2022-026520).

### SUMMARY OF THE INVENTION

In order to reduce eddy current loss in a magnetically coupled coil component, it is conceivable to provide external electrodes on a surface parallel with the coil axis as in the array-type coil component described in Japanese Patent Application Laid-Open Publication No. 2022-026520. However, in a magnetically coupled coil component, adjacent external electrodes are disposed at a relatively large distance from each other in order to avoid short circuits. Therefore, when the external electrodes are simply provided on a surface parallel with the coil axis, there is the large distance between the pair of coil conductors, which thus cannot avoid a reduction in the coupling coefficient with each other.

An object of the present disclosure is to provide a magnetically coupled coil component capable of reducing eddy current loss while avoiding a reduction in the coupling coefficient.

According to an embodiment of the present disclosure, a magnetically coupled coil component includes: a magnetic substrate having a first surface; a first coil conductor provided in the magnetic substrate, and including a first loop part wound around a coil axis extending in a direction parallel with the first surface, a first lead-out part connected to one end of the first loop part, and a third lead-out part connected to the other end of the first loop part; a second coil conductor provided in the magnetic substrate, and including a second loop part wound around the coil axis, a second lead-out part connected to one end of the second loop part, and a fourth lead-out part connected to the other end of the second loop part; a first external electrode provided on the magnetic substrate to contact at least the first surface, and connected to the first lead-out part; a second external electrode provided on the magnetic substrate to contact at least the first surface, and connected to the second lead-out part; a third external electrode provided on the magnetic substrate to contact at least the first surface, and connected to the third lead-out part; and a fourth external electrode provided on the magnetic substrate to contact at least the first surface, and connected to the fourth lead-out part, wherein the first lead-out part includes: a first routing part extending from the one end of the first loop part in a direction away from the second coil conductor; and a first connection part connecting the first routing part and the first external electrode, and wherein the second lead-out part includes: a second routing part extending from the one end of the second loop part in a direction away from the first coil conductor; and a second connection part connecting the second routing part and the second external electrode.

According to the present disclosure, it is possible to reduce eddy current loss while avoiding a reduction in the coupling coefficient.

### BRIEF DESCRIPTION OF THE DRAWINGS

FIG. 1 is an oblique view showing a magnetically coupled coil component according to a first embodiment;

FIG. 2 is an exploded view showing the magnetically coupled coil component according to the first embodiment;

FIG. 3A is a plan view showing a magnetic film and a conductor pattern provided on the magnetic film in the first embodiment;

FIG. 3B is a plan view showing a magnetic film and a conductor pattern provided on the magnetic film in the first embodiment;

FIG. 3C is a plan view showing a magnetic film and a conductor pattern provided on the magnetic film in the first embodiment;

FIG. 3D is a plan view showing a magnetic film and a conductor pattern provided on the magnetic film in the first embodiment;

FIG. 3E is a plan view showing a magnetic film and a conductor pattern provided on the magnetic film in the first embodiment;

FIG. 3F is a plan view showing a magnetic film and a conductor pattern provided on the magnetic film in the first embodiment;

FIG. 3G is a plan view showing a magnetic film and a conductor pattern provided on the magnetic film in the first embodiment;

FIG. 3H is a plan view showing a magnetic film and a conductor pattern provided on the magnetic film in the first embodiment;

FIG. 4 is an oblique view showing a use example of the coil component according to the first embodiment;

FIG. 5 is a diagram showing a preferred arrangement of a first loop part and a second loop part;

FIG. 6 is an oblique view showing a magnetically coupled coil component according to a second embodiment;

FIG. 7 is an exploded view showing a magnetically coupled coil component according to a third embodiment;

FIG. 8A is a plan view showing a magnetic film and a conductor pattern provided on the magnetic film in the third embodiment;

FIG. 8B is a plan view showing a magnetic film and a conductor pattern provided on the magnetic film in the third embodiment;

FIG. 8C is a plan view showing a magnetic film and a conductor pattern provided on the magnetic film in the third embodiment;

FIG. 8D is a plan view showing a magnetic film and a conductor pattern provided on the magnetic film in the third embodiment;

FIG. 8E is a plan view showing a magnetic film and a conductor pattern provided on the magnetic film in the third embodiment;

FIG. 8F is a plan view showing a magnetic film and a conductor pattern provided on the magnetic film in the third embodiment;

FIG. 8G is a plan view showing a magnetic film and a conductor pattern provided on the magnetic film in the third embodiment; and

FIG. 8H is a plan view showing a magnetic film and a conductor pattern provided on the magnetic film in the third embodiment.

### DETAILED DESCRIPTION OF THE DISCLOSURE

Although embodiments of the present disclosure will be described in detail below, the present disclosure is not limited thereto. In this specification and drawings, components having substantially the same functional configuration may be denoted by the same reference numerals, thereby omitting redundant descriptions. In addition, it should be noted that each drawing is not necessarily to scale for convenience of description.

### First Embodiment

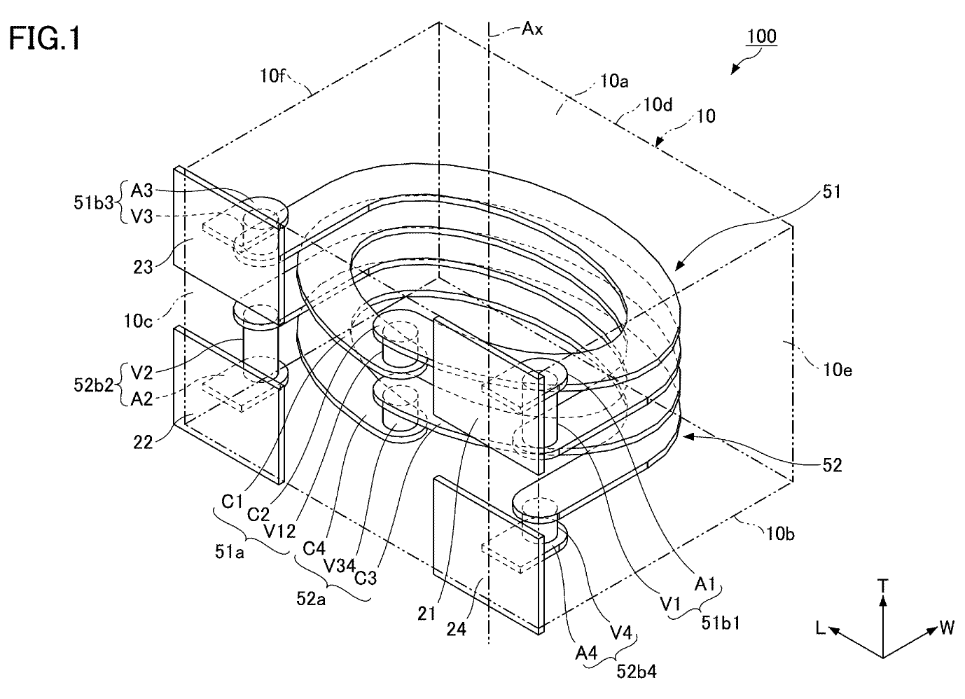

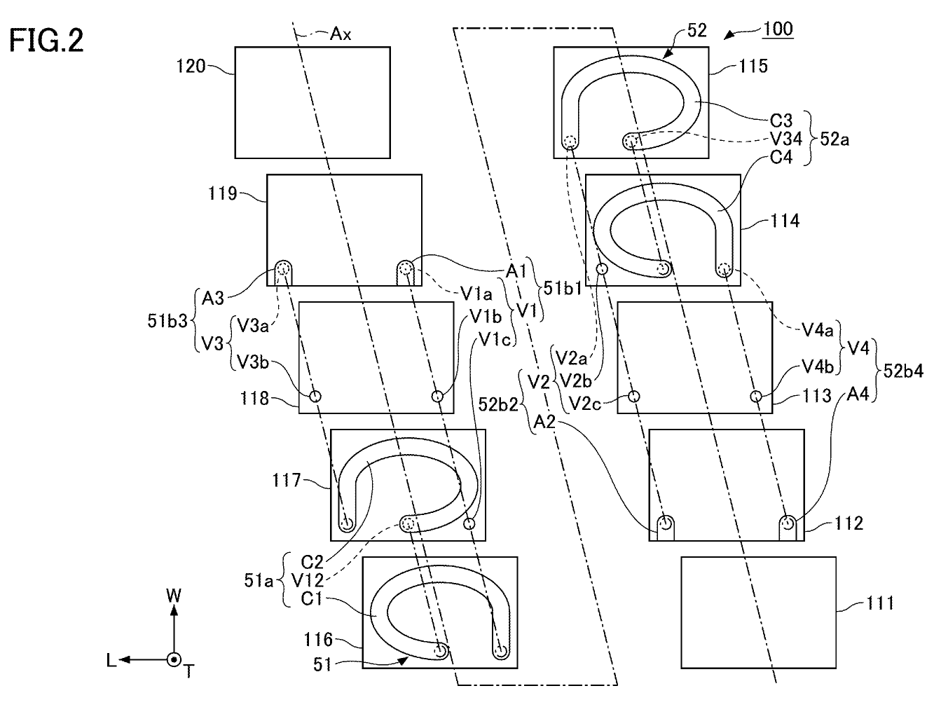

A first embodiment will be described. The first embodiment relates to a magnetically coupled coil component including two coil conductors. FIG. 1 is an oblique view showing the magnetically coupled coil component according to the first embodiment. FIG. 2 is an exploded view showing the magnetically coupled coil component according to the first embodiment. In FIG. 2, illustration of external electrodes is omitted for convenience of explanation.

As shown in FIGS. 1 and 2, a magnetically coupled coil component 100 according to the first embodiment includes a magnetic substrate 10, a first coil conductor 51, a second coil conductor 52, a first external electrode 21, a second external electrode 22, a third external electrode 23, and a fourth external electrode 24. Hereinafter, the “magnetically coupled coil component” may be referred to as “coil component”, and “magnetic substrate” may be referred to as “substrate”. The first coil conductor 51 and the second coil conductor 52 are provided in the magnetic substrate 10. The first coil conductor 51 and the second coil conductor 52 are electrically insulated from each other in the substrate 10.

In this specification, unless otherwise understood from the context, the “length” direction, the “width” direction, and the “thickness” direction of the coil component 100 are the “L” direction, the “W” direction, and the “T” direction in FIGS. 1 and 2, respectively.

The substrate 10 is configured in a rectangular parallelepiped shape. The length dimension of the coil component 100 may be greater than the width dimension thereof. The term “rectangular parallelepiped” or “rectangular parallelepiped shape” herein does not mean only “rectangular parallelepiped” in a mathematically strict sense.

The magnetic substrate 10 has a first main surface 10a, a second main surface 10b, a first end surface 10c, a second end surface 10d, a first side surface 10e, and a second side surface 10f. The first end surface 10c, the second end surface 10d, the first side surface 10e, and the second side surface 10f are connected to the second main surface 10b. The first end surface 10c connects the first side surface 10e and the second side surface 10f. The second end surface 10d also connects the first side surface 10e and the second side surface 10f. The corners and sides of the substrate 10 may be curved. When the sides of the substrate 10 are curved, adjacent surfaces among the first main surface 10a, the second main surface 10b, the first end surface 10c, the second end surface 10d, the first side surface 10e, and the second side surface 10f are connected via curved surfaces. In this way, the first end surface 10c, the second end surface 10d, the first side surface 10e, and the second side surface 10f are connected to the second main surface 10b directly or indirectly via curved surfaces. When the sides of the substrate 10 are curved, the outer surface of the substrate 10 is defined by the first main surface 10a, the second main surface 10b, the first end surface 10c, the second end surface 10d, the first side surface 10e, and the second side surface 10f, and curved surfaces connecting adjacent surfaces among these surfaces. The first end surface 10c is an example of a first surface. The first side surface 10e is an example of a second surface. The second side surface 10f is an example of a third surface.

When referring to the positional arrangement of the coil component 100 or its constituent parts in the vertical direction in this specification, the side on which the first main surface 10a is located as seen from the second main surface 10b is referred to as the “upper side”, and the side on which the second main surface 10b is located as seen from the first main surface 10a is referred to as the “lower side”, unless it is necessary to interpret otherwise. When expressing the vertical direction using the coordinate axes shown in FIG. 1, the positive direction on the T-axis is referred to as the “upper side”, and the negative side in the T-axis direction is referred to as the “lower side”.

The first main surface 10a and the second main surface 10b form both end surfaces in the height direction of the substrate 10, the first end surface 10c and the second end surface 10d form both end surfaces in the width direction of the substrate 10, and the first side surface 10e and the second side surface 10f form both end surfaces in the length direction of the substrate 10. As shown in FIG. 1, since the first main surface 10a is located on the upper part of the substrate 10, the first main surface 10a may be referred to as a “upper surface”. Similarly, the second main surface 10b may be referred to as a “lower surface” or a “bottom surface”. Since the coil component 100 is located such that the first end surface 10c faces an assembly substrate, the first end surface 10c may be referred to as a “assembling surface”. The first main surface 10a and the second main surface 10b are spaced apart by the height dimension of the substrate 10, the first end surface 10c and the second end surface 10d are spaced apart by the width dimension of the substrate 10, and the first side surface 10e and the second side surface 10f are spaced apart by the length dimension of the substrate 10.

The substrate 10 is composed of a magnetic material. As the magnetic material for the substrate 10, a soft magnetic alloy material, a composite magnetic material in which magnetic particles are dispersed in a resin, a ferrite material, or any other publicly-known magnetic material may be used.

Soft magnetic metal particles contained in the magnetic material for the substrate 10 may contain at least one element selected from Fe, Ni, and Co as a main component, and may contain at least one element selected from Si, Cr, Al, B, and P as an additive. The soft magnetic metal particles contained in the magnetic material for the substrate 10 may be, for example, crystalline alloy particles of an Fe-Si-Cr alloy, an Fe-Si-Al alloy, an Fe-Ni alloy, and the like, may be amorphous alloy particles of an Fe-Si-Cr-B-C alloy, an Fe-Si-Cr-B alloy, and the like, or may be mixed particles obtained by mixing these. The composition of the soft magnetic metal particles contained in the substrate 10 is not limited to those described above. For example, the soft magnetic metal particles contained in the substrate 10 may be a Co-Nb-Zr alloy, an Fe-Zr-Cu-B alloy, an Fe-Si-B alloy, an Fe-Co-Zr-Cu-B alloy, a Ni-Si-B alloy, or an Fe-Al-Cr alloy.

An insulating film may be formed on the surface of each of the soft magnetic metal particles contained in the substrate 10. The insulating film may be an oxide film formed through oxidation of an element contained in the soft magnetic metal particles contained in the magnetic material.

The soft magnetic metal particles contained in the substrate 10 have an average particle diameter of, for example, 1 μm to 40 μm. The substrate 10 may contain two or more types of soft magnetic metal particles having different average particle diameters. The soft magnetic metal particles contained in the substrate 10 may contain first soft magnetic metal particles having an average particle diameter of 1 μm to 40 μm, and second soft magnetic metal particles having an average particle diameter smaller than that of the first soft magnetic metal particles. The average particle diameter of the second soft magnetic metal particles is, for example, 0.1 μm to 0.5 μm. By including two types of soft magnetic metal particles having different average particle diameters in the substrate 10, it is possible to improve the percentage at which the substrate 10 is filled with metal magnetic particles. The volume proportion of the metal magnetic particles relative to the total volume of the substrate 10 may be 85 vol% or greater, or 88 vol% or greater. By improving the filling percentage of the soft magnetic metal particles contained in the substrate 10, it is possible to improve the magnetic characteristics of the substrate 10. Further, by improving the filling percentage of the soft magnetic metal particles contained in the substrate 10, it is possible to improve the mechanical strength of the substrate 10. The average particle diameter of the soft magnetic metal particles contained in the substrate 10 is determined based on a volume-based particle size distribution obtained based on an SEM image, captured by a scanning electron microscope (SEM), of a cross-section of the substrate 10 exposed by cutting the substrate 10 in the thickness direction (T-axis direction). For example, the average particle diameter (median diameter (D50)) calculated from the volume-based particle size distribution obtained based on the SEM image can be used as the average particle diameter of the soft magnetic metal particles contained in the substrate 10. The particle diameter of the first soft magnetic metal particles may be dispersed in a range of 1 μm to 60 μm. The particle diameter of the second soft magnetic metal particles may be dispersed in a range of 0.01 μm to 1 μm.

In the substrate 10, the soft magnetic metal particles may be bonded to each other by an oxide film formed through oxidation of an element contained in the soft magnetic metal particles in the manufacturing process. The substrate 10 may contain a binder in addition to the soft magnetic metal particles. When the substrate 10 contains a binder, the soft magnetic metal particles may be bonded to each other by the binder. The binder contained in the substrate 10 may be formed, for example, by curing a thermosetting resin having excellent insulating characteristics. As the material of the binder, for example, an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin can be used. The binder contained in the substrate 10 is not limited to the above. For example, the binder contained in the substrate 10 may be glass.

The first coil conductor 51 includes a first loop part 51a, a first lead-out part 51b1, and a third lead-out part 51b3. The second coil conductor 52 includes a second loop part 52a, a second lead-out part 52b2, and a fourth lead-out part 52b4. The first loop part 51a and the second loop part 52a extend in the circumferential direction about a coil axis Ax extending along the T-axis direction. That is, the first loop part 51a and the second loop part 52a are wound around the coil axis Ax extending in a direction parallel with the first end surface 10c. The first lead-out part 51b1 is connected to one end of the first loop part 51a. The third lead-out part 51b3 is connected to the other end of the first loop part 51a. The second lead-out part 52b2 is connected to one end of the second loop part 52a. The fourth lead-out part 52b4 is connected to the other end of the second loop part 52a.

The first external electrode 21, the second external electrode 22, the third external electrode 23, and the fourth external electrode 24 are provided on the substrate 10 to contact the first end surface 10c. The first external electrode 21, the second external electrode 22, the third external electrode 23, and the fourth external electrode 24 are disposed to be separated from each other. The first external electrode 21 is connected to the first lead-out part 51b1. The second external electrode 22 is connected to the second lead-out part 52b2. The third external electrode 23 is connected to the third lead-out part 51b3. The fourth external electrode 24 is connected to the fourth lead-out part 52b4.

As shown in FIG. 2, the substrate 10 includes magnetic films 111 to 120. The substrate 10 is a laminate in which the magnetic films 111 to 120 are laminated. The magnetic film 112 is present on the magnetic film 111, the magnetic film 113 is present on the magnetic film 112, and the magnetic film 114 is present on the magnetic film 113. The magnetic film 115 is present on the magnetic film 114, the magnetic film 116 is present on the magnetic film 115, and the magnetic film 117 is present on the magnetic film 116. The magnetic film 118 is present on the magnetic film 117, the magnetic film 119 is present on the magnetic film 118, and the magnetic film 120 is present on the magnetic film 119. The boundaries between the magnetic films 111 to 120 may not be visible even when a cross-section of the substrate 10 is observed by an SEM. Conductor patterns are formed on the upper surfaces of the magnetic films 112, 114, 115, 116, 117, and 119. A second connection part A2 and a fourth connection part A4 are formed as conductor patterns on the upper surface of the magnetic film 112. A fourth conductor pattern C4 is formed on the upper surface of the magnetic film 114, and a third conductor pattern C3 is formed on the upper surface of the magnetic film 115. A first conductor pattern C1 is formed on the upper surface of the magnetic film 116, and a second conductor pattern C2 is formed on the upper surface of the magnetic film 117. A first connection part A1 and a third connection part A3 are formed as conductor patterns on the upper surface of the magnetic film 119. The first conductor pattern C1, the second conductor pattern C2, the third conductor pattern C3, and the fourth conductor pattern C4 all extend in the circumferential direction about the coil axis Ax extending along the T-axis direction. The coil axis Ax passes through the intersection of two diagonal lines of, for example, the magnetic film 117 having a rectangular shape in a plan view. The coil axis Ax may pass through the geometric center of the magnetic film 117 in a plan view. The first connection part A1, the second connection part A2, the third connection part A3, and the fourth connection part A4 are exposed from the substrate 10 on the first end surface 10c.

At predetermined positions of the magnetic films 113 to 115 and 117 to 119, through-holes penetrating the respective magnetic films in the T-axis direction are formed, and via conductors are embedded in the through-holes. Each of the conductor patterns and the via conductors of the coil component 100 is formed by, for example, printing a conductive paste containing a metal or an alloy having excellent conductivity on a magnetic material sheet, which is a precursor of each of the magnetic films 112 to 119, by a screen printing method, and heating the conductive paste printed on the magnetic material sheet. As the material of the conductive paste, Ag, Pd, Cu, Al, or an alloy thereof may be used. The conductor patterns and the via conductors of the coil component 100 may be composed of a material other than the above. The conductor patterns and the via conductors of the coil component 100 may be formed by, for example, a sputtering method, an inkjet method, or a publicly-known method other than these.

Although the magnetic film 111 is illustrated as a single-layer sheet-like member, the magnetic film 111 may be a laminate formed by laminating a plurality of sheet-like members. Similarly, each of the magnetic films 112 to 120 may be a laminate formed by laminating a plurality of sheet-like members. By adjusting the number of sheets constituting the magnetic films 111 to 120, it is possible to adjust the thickness of each of the magnetic films 111 to 120.

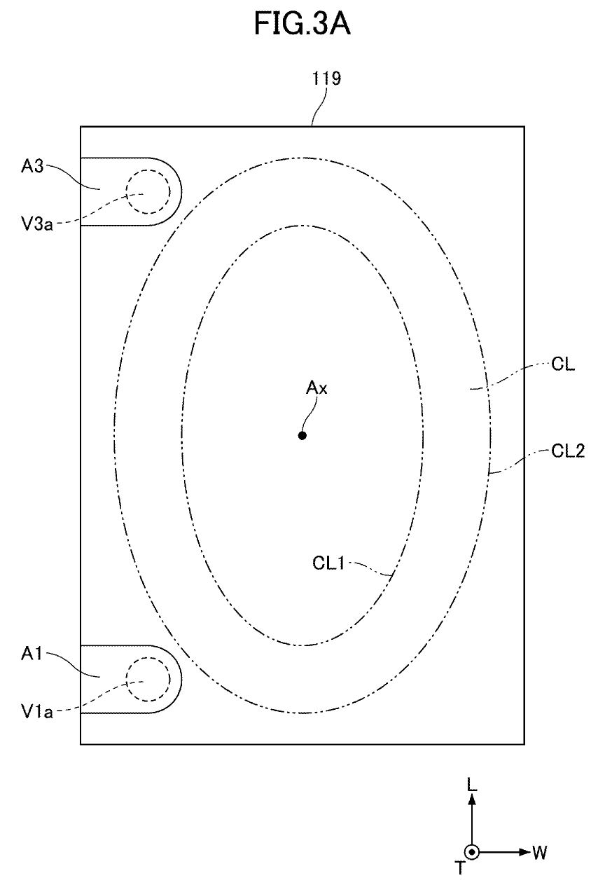

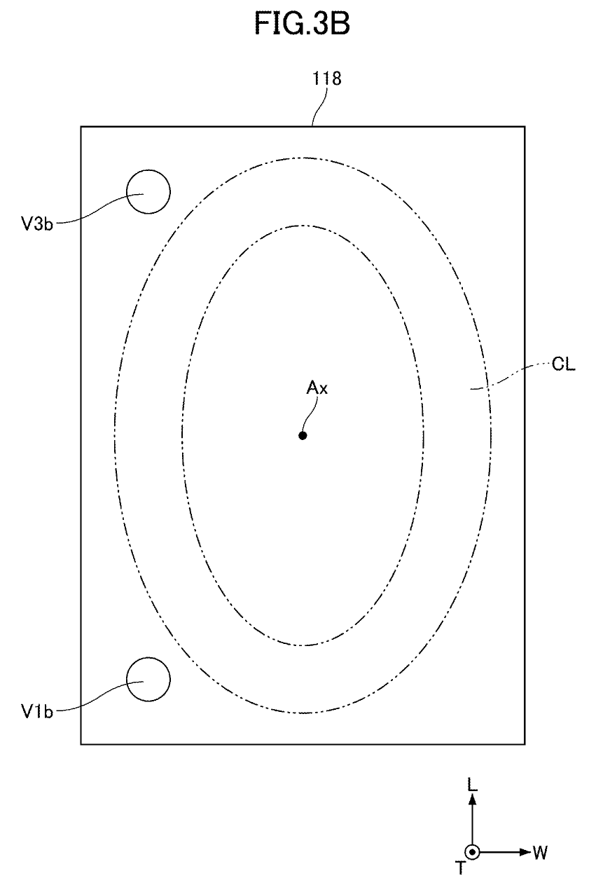

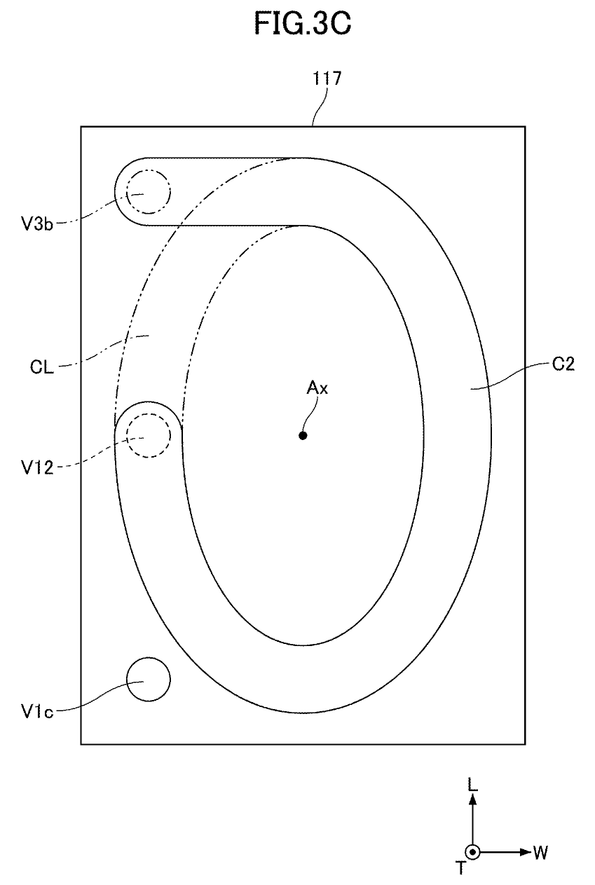

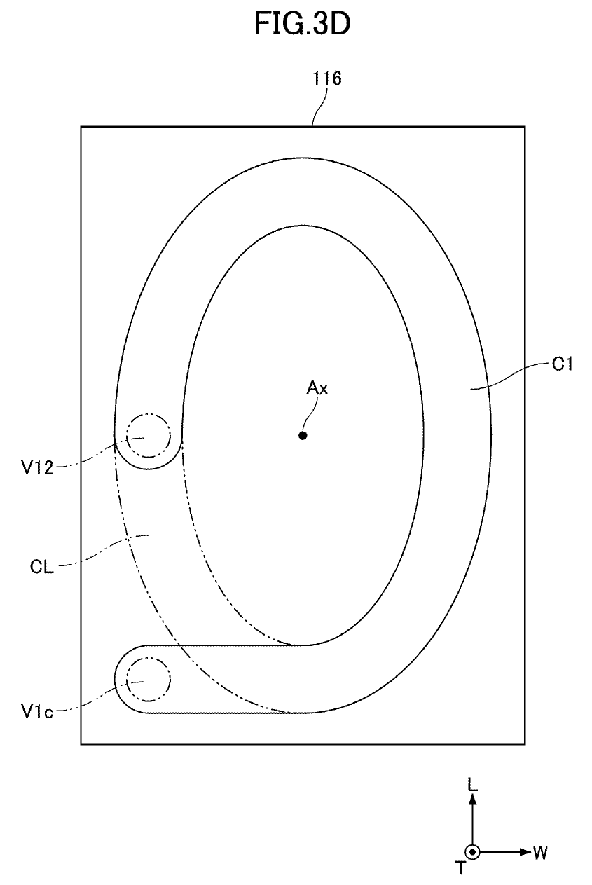

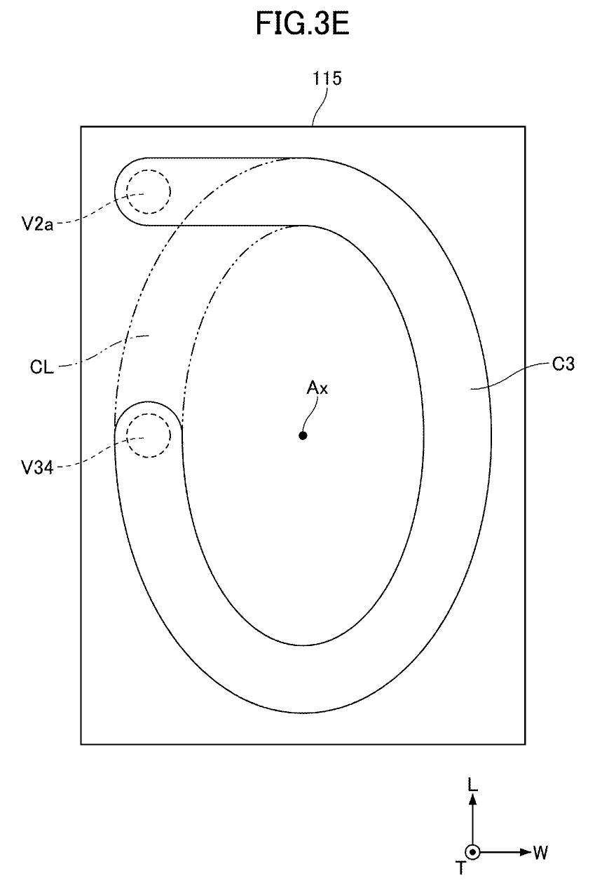

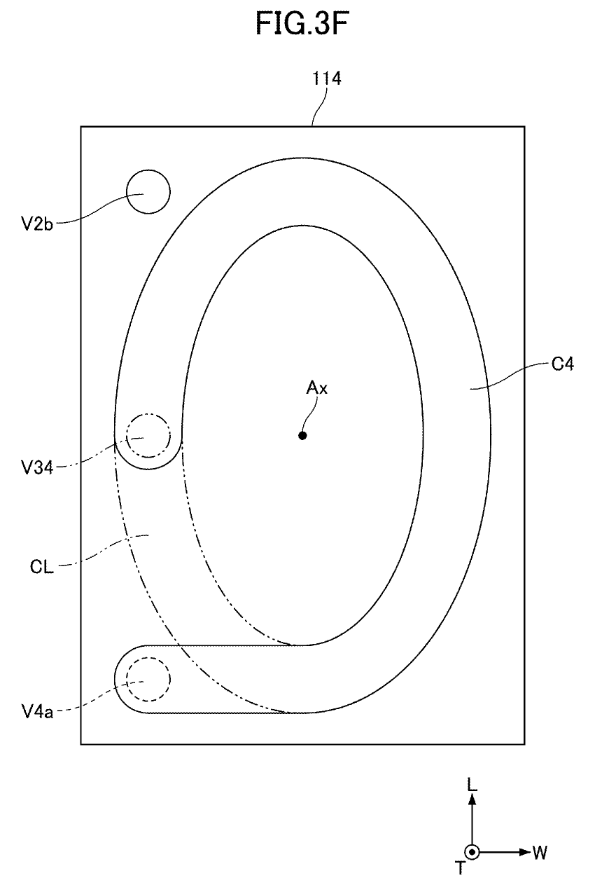

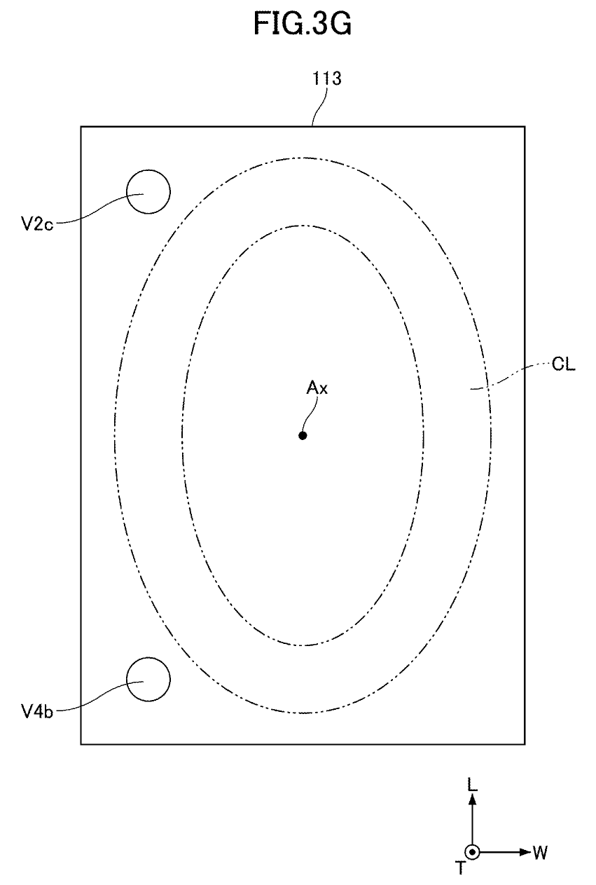

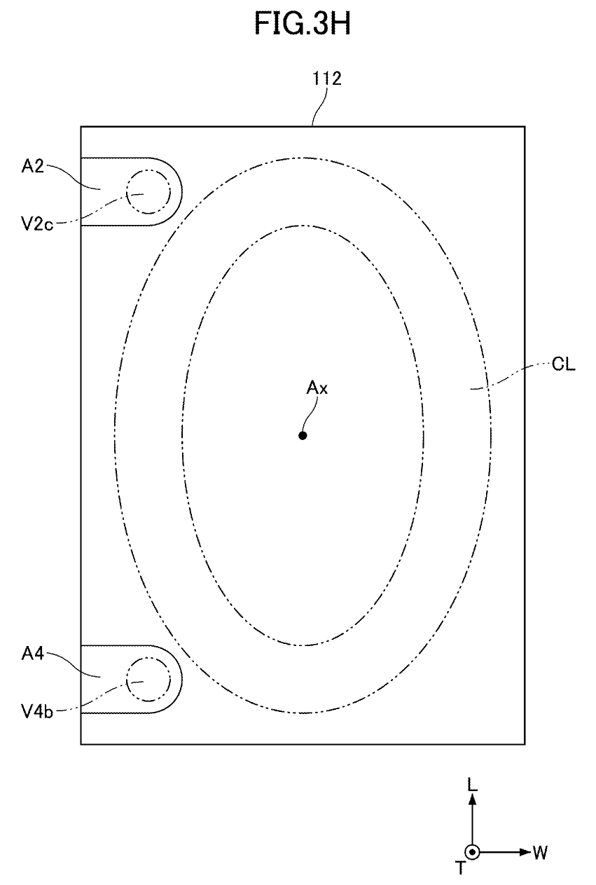

The conductor patterns and via conductors of the coil component 100 will be further described. FIGS. 3A, 3B, 3C, 3D, 3E, 3F, 3G, and 3H are plan views showing the magnetic films 119, 118, 117, 116, 115, 114, 113, and 112, respectively.

As shown in FIGS. 2 and 3A, the first connection part A1 and the third connection part A3 are formed on the upper surface of the magnetic film 119. A through-hole penetrating the magnetic film 119 in the T-axis direction is provided in a region of the magnetic film 119 overlapping the first connection part A1, and a via conductor V1a is embedded in the through-hole. A through-hole penetrating the magnetic film 119 in the T-axis direction is provided in a region of the magnetic film 119 overlapping the third connection part A3, and a via conductor V3a is embedded in the through-hole.

As shown in FIGS. 2 and 3B, a through-hole penetrating the magnetic film 118 in the T-axis direction is provided in a region of the magnetic film 118 overlapping the via conductor V1a in a plan view, and a via conductor V1b is embedded in the through-hole. The via conductor V1b is connected to the via conductor V1a. A through-hole penetrating the magnetic film 118 in the T-axis direction is provided in a region of the magnetic film 118 overlapping the via conductor V3a in a plan view, and a via conductor V3b is embedded in the through-hole. The via conductor V3b is connected to the via conductor V3a.

As shown in FIGS. 2 and 3C, the second conductor pattern C2 is formed on the upper surface of the magnetic film 117. The second conductor pattern C2 extends in the circumferential direction about the coil axis Ax in a plane (LW plane) orthogonal to the coil axis Ax by a number of turns that is less than one turn. The second conductor pattern C2 extends in the circumferential direction about the coil axis Ax by approximately 0.75 turns (270°). One end of the second conductor pattern C2 is connected to the via conductor V3b. Further, a through-hole penetrating the magnetic film 117 in the T-axis direction is provided in a region of the magnetic film 117 overlapping the other end of the second conductor pattern C2, and a via conductor V12 is embedded in the through-hole. Further, a through-hole penetrating the magnetic film 117 in the T-axis direction is provided in a region of the magnetic film 117 overlapping the via conductor V1b in a plan view, and a via conductor V1c is embedded in the through-hole. The via conductor V1c is connected to the via conductor V1b.

As shown in FIGS. 2 and 3D, the first conductor pattern C1 is formed on the upper surface of the magnetic film 116. The first conductor pattern C1 extends in the circumferential direction about the coil axis Ax in a plane (LW plane) orthogonal to the coil axis Ax by a number of turns that is less than one turn. The first conductor pattern C1 extends in the circumferential direction about the coil axis Ax by approximately 0.75 turns (270°). One end of the first conductor pattern C1 is connected to the via conductor V12. The other end of the first conductor pattern C1 is connected to the via conductor V1c.

As shown in FIGS. 2 and 3E, the third conductor pattern C3 is formed on the upper surface of the magnetic film 115. The third conductor pattern C3 has a shape that is linearly symmetrical with the first conductor pattern C1 with respect to an axial line that intersects the coil axis Ax and extends along the W-axis as the axis of symmetry. A through-hole penetrating the magnetic film 115 in the T-axis direction is provided in a region of the magnetic film 115 overlapping one end of the third conductor pattern C3, and a via conductor V2a is embedded in the through-hole. A through-hole penetrating the magnetic film 115 in the T-axis direction is provided in a region of the magnetic film 115 overlapping the other end of the third conductor pattern C3, and a via conductor V34 is embedded in the through-hole.

As shown in FIGS. 2 and 3F, the fourth conductor pattern C4 is formed on the upper surface of the magnetic film 114. The fourth conductor pattern C4 has a shape that is linearly symmetrical with the second conductor pattern C2 with respect to an axial line intersecting the coil axis Ax and extending along the W axis as the axis of symmetry. One end of the fourth conductor pattern C4 is connected to the via conductor V34. Further, a through-hole penetrating the magnetic film 114 in the T-axis direction is provided in a region overlapping the other end of the fourth conductor pattern C4, and a via conductor V4a is embedded in the through-hole. Further, a through-hole penetrating the magnetic film 114 in the T-axis direction is provided in a region of the magnetic film 114 overlapping the via conductor V2a in a plan view, and a via conductor V2b is embedded in the through-hole. The via conductor V2b is connected to the via conductor V2a.

As shown in FIGS. 2 and 3G, a through-hole penetrating the magnetic film 113 in the T-axis direction is provided in a region of the magnetic film 113 overlapping the via conductor V2b in a plan view, and a via conductor V2c is embedded in the through-hole. The via conductor V2c is connected to the via conductor V2b. A through-hole penetrating the magnetic film 113 in the T-axis direction is provided in a region of the magnetic film 113 overlapping the via conductor V4a in a plan view, and a via conductor V4b is embedded in the through-hole. The via conductor V4b is connected to the via conductor V4a.

As shown in FIGS. 2 and 3H, the second connection part A2 and the fourth connection part A4 are formed on the upper surface of the magnetic film 112. The second connection part A2 is formed in a region overlapping the via conductor V2c in a plan view and is connected to the via conductor V2c. The fourth connection part A4 is formed in a region overlapping the via conductor V4b in a plan view and is connected to the via conductor V4b.

In this way, the first conductor pattern C1 and the second conductor pattern C2 are connected in series via the via conductor V12. The first conductor pattern C1, the via conductor V12, and the second conductor pattern C2 constitute the first loop part 51a having a spiral shape extending by approximately 1.5 turns around the coil axis Ax in the substrate 10. The third conductor pattern C3 and the fourth conductor pattern C4 are connected in series via the via conductor V34. The third conductor pattern C3, the via conductor V34, and the fourth conductor pattern C4 constitute the second loop part 52a having a spiral shape extending by approximately 1.5 turns around the coil axis Ax in the substrate 10.

The first lead-out part 51b1 includes a first routing part V1 and the first connection part A1. The first routing part V1 includes the via conductors V1a, V1b, and V1c arranged on the same axial line extending in parallel with the T-axis, and extends from the one end of the first loop part 51a in a direction away from the second coil conductor 52 (in the positive direction on the T-axis). The first connection part A1 connects the first routing part V1 and the first external electrode 21. That is, the one end of the first loop part 51a is connected to the first external electrode 21 via the first lead-out part 51b1. The via conductors V1a, V1b, and V1c are examples of routing via conductors.

The third lead-out part 51b3 includes a third routing part V3 and the third connection part A3. The third routing part V3 includes the via conductors V3a and V3b arranged on the same axial line extending in parallel with the T-axis, and extends from the other end of the first loop part 51a in the direction away from the second coil conductor 52 (in the positive direction on the T-axis). The third connection part A3 connects the third routing part V3 and the third external electrode 23. That is, the other end of the first loop part 51a is connected to the third external electrode 23 via the third lead-out part 51b3. The via conductors V3a and V3b are examples of routing via conductors.

The second lead-out part 52b2 includes a second routing part V2 and the second connection part A2. The second routing part V2 includes the via conductors V2a, V2b, and V2c arranged on the same axial line extending in parallel with the T-axis, and extends from the one end of the second loop part 52a in a direction away from the first coil conductor 51 (in the negative direction on the T-axis). The second connection part A2 connects the second routing part V2 and the second external electrode 22. That is, the one end of the second loop part 52a is connected to the second external electrode 22 via the second lead-out part 52b2. The via conductors V2a, V2b, and V2c are examples of routing via conductors.

The fourth lead-out part 52b4 includes a fourth routing part V4 and the fourth connection part A4. The fourth routing part V4 includes the via conductors V4a and V4b arranged on the same axial line extending in parallel with the T-axis, and extends from the other end of the second loop part 52a in the direction away from the first coil conductor 51 (in the negative direction on the T-axis). The fourth connection part A4 connects the fourth routing part V4 and the fourth external electrode 24. That is, the other end of the second loop part 52a is connected to the fourth external electrode 24 via the fourth lead-out part 52b4. The via conductors V4a and V4b are examples of routing via conductors.

When the coil component 100 is viewed in a plan view (when viewed in the T-axis direction), a part of the first loop part 51a and a part of the second loop part 52a extend along an elliptical closed loop track CL by one or more turns. The closed loop track CL refers to a region between an elliptical inner circumferential surface CL1 and an outer circumferential surface CL2 having an elliptical shape larger in diameter than the inner circumferential surface CL1. The shape of the closed loop track CL is not limited to an elliptical shape. In a plan view, the shape of the closed loop track CL may be an oval, a circle, a rectangle, a polygon, or other shapes.

Next, an example of the method for manufacturing the coil component 100 will be described. The coil component 100 can be manufactured by, for example, a lamination process. Hereinafter, an example of the method for manufacturing the coil component 100 by a sheet lamination method will be described.

First, a magnetic material sheet, which is the precursor of each of the magnetic films (the magnetic films 111 to 120) constituting the substrate 10 is manufactured. The magnetic material sheet is manufactured by, for example, kneading a soft magnetic metal powder with a resin to prepare a slurry, applying the slurry to the surface of a plastic base film by a doctor blade method or any other common method, drying the slurry, and cutting the dried slurry to a predetermined size.

Next, through-holes are formed at predetermined positions of each magnetic material sheet as the precursor of each of the magnetic films 113 to 115 and 117 to 119 to penetrate each magnetic material sheet in the T-axis direction. Next, a conductive paste is printed on the upper surface of each of the magnetic material sheets, which become the magnetic films 112 to 119, by a screen printing method, to form an unfired conductor pattern on each magnetic material sheet, and the conductive paste is embedded in the through-holes formed in each magnetic material sheet. Each conductor pattern can be formed by various publicly-known methods other than the screen printing method.

The two unfired conductor patterns formed on a magnetic material sheet, which is the precursor of the magnetic film 119, become the first connection part A1 and the third connection part A3 after being heated, and the unfired conductive paste embedded in the two through-holes in this magnetic material sheet becomes the via conductors V1a and V3a after being heated. The unfired conductive paste embedded in the two through-holes in a magnetic material sheet, which is the precursor of the magnetic film 118, become the via conductors V1b and V3b after being heated. The unfired conductor pattern formed on a magnetic material sheet, which is the precursor of the magnetic film 117, becomes the second conductor pattern C2 after being heated, and the unfired conductive paste embedded in the two through-holes of this magnetic material sheet become the via conductors V1c and V12 after being heated. The unfired conductor pattern formed on a magnetic material sheet, which is the precursor of the magnetic film 116, becomes the first conductor pattern C1 after being heated.

The unfired conductor pattern formed on a magnetic material sheet, which is the precursor of the magnetic film 115, becomes the third conductor pattern C3 after being heated, and the unfired conductive paste embedded in the two through-holes of this magnetic material sheet becomes the via conductors V2a and V34 after being heated. The unfired conductor pattern formed on a magnetic material sheet, which is the precursor of the magnetic film 114, becomes the fourth conductor pattern C4 after being heated, and the unfired conductive paste embedded in the two through-holes of this magnetic material sheet becomes the via conductors V2b and V4a after being heated. The unfired conductive paste embedded in the two through-holes of a magnetic material sheet, which is the precursor of the magnetic film 113, become the via conductors V2c and V4b after being heated. The two unfired conductor patterns formed on a magnetic material sheet, which is the precursor of the magnetic film 112, become the second connection part A2 and the fourth connection part A4 after being heated.

A magnetic material sheet, which is the precursor of the magnetic film 111, may be one magnetic material sheet or a laminate sheet in which a plurality of magnetic material sheets are laminated. Similarly, the magnetic material sheet, which is the precursor of each of the magnetic films 112 to 120, may be one magnetic material sheet or a laminate sheet in which a plurality of magnetic material sheets are laminated. By adjusting the number of magnetic material sheets constituting the magnetic films 111 to 120, it is possible to adjust the thickness of each of the magnetic films 111 to 120.

Next, the magnetic material sheets, which are the precursors of the magnetic films 111 to 120, are laminated to obtain a laminate. In order to obtain a laminate, the magnetic material sheets that are laminated may be thermocompression-bonded by a press machine. Next, the laminate is singulated into a desired size using a cutting machine, such as a dicing machine, a laser processing machine, and the like, to obtain a chip laminate. The end parts of the chip laminate may be subjected to a polishing process, such as barrel polishing and the like, if necessary.

Next, the chip laminate is debinded, and the debinded chip laminate is subjected to heat treatment. In this way, the substrate 10 is obtained. By this heat treatment, an oxide layer is formed on the surface of each of the soft magnetic metal powder particles contained in the magnetic material sheet, and adjacent soft magnetic metal powder particles are bonded via the oxide layer. The heat treatment on the chip laminate is performed at a heating temperature of, for example, 600° C to 800° C for a heating time of 20 minutes to 120 minutes.

Next, a conductor paste is applied to the first end surface 10c, which is the assembling surface of the substrate 10, and then fired, to form the first external electrode 21, the second external electrode 22, the third external electrode 23, and the fourth external electrode 24. The first external electrode 21, the second external electrode 22, the third external electrode 23, and the fourth external electrode 24 may include a plated layer. This plated layer may include two or more layers. The two plated layers may include a Ni-plated layer and a Sn-plated layer provided on the outer side of the Ni-plated layer. In the way described above, the coil component 100 is obtained.

The coil component 100 may be manufactured by a compression molding method, a thin film processing method, a slurry building method, or any other publicly-known method.

Some of the steps included in the above manufacturing method may be omitted where appropriate. In the method for manufacturing the coil component 100, steps not explicitly described herein may be performed as needed. Some of the steps included in the above method for manufacturing the coil component 100 may be performed with their orders interchanged at any time as long as such order change falls within the spirit of the present disclosure. Some of the steps included in the above method for manufacturing the coil component 100 may be performed simultaneously or in parallel if possible.

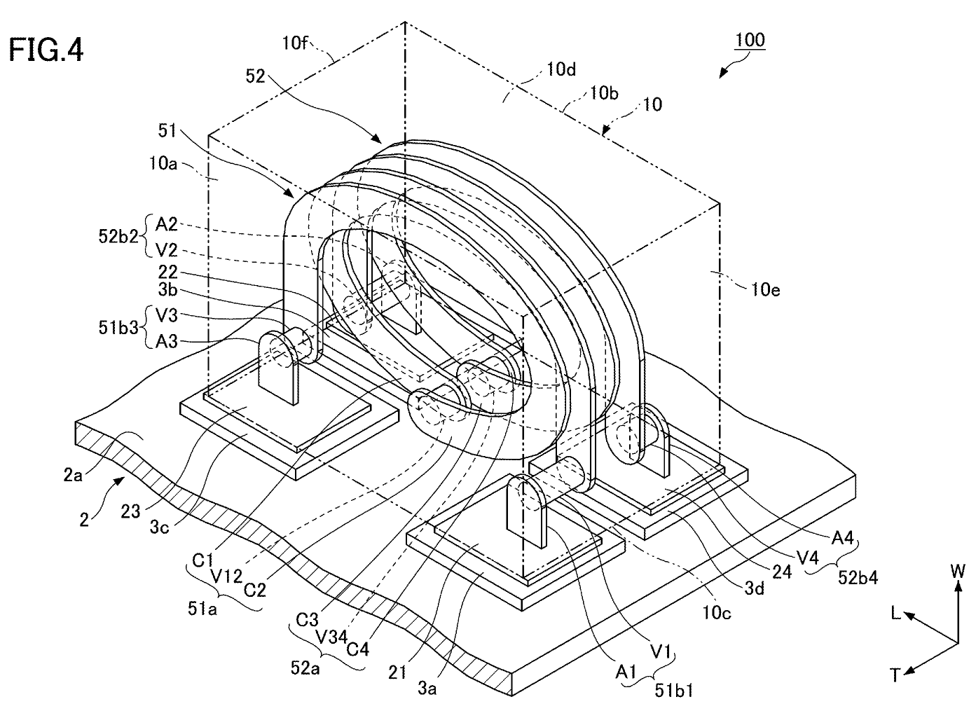

Next, an example of use of the coil component 100 will be described. FIG. 4 is an oblique view showing an example of use of the coil component 100 according to the first embodiment.

The coil component 100 may be assembled on an assembly substrate 2a. The assembly substrate 2a is provided with lands 3a, 3b, 3c, and 3d. The coil component 100 is assembled on the assembly substrate 2a by joining the first external electrode 21 and the land 3a, joining the second external electrode 22 and the land 3b, joining the third external electrode 23 and the land 3c, and joining the fourth external electrode 24 and the land 3d. For example, a conductive joining material, such as solder and the like is used for the joining. A circuit substrate 2 includes the coil component 100 and the assembly substrate 2a on which the coil component 100 is assembled. The circuit substrate 2 may be mounted on various electronic devices. Examples of electronic devices on which the circuit substrate 2 may be mounted include smartphones, tablet terminals, game consoles, auto electric parts, servers, and various other electronic devices.

The coil component 100 may be an inductor, a transformer, a filter, a reactor, an inductor array, and various other coil components. The coil component 100 may be a coupled inductor, a choke coil, and various other magnetically coupled coil components. Applications of the coil component 100 are not limited to those described herein.

In the coil component 100 according to the first embodiment, as shown in FIGS. 1 and 2, the first external electrode 21, the second external electrode 22, the third external electrode 23, and the fourth external electrode 24 are provided on the first end surface 10c, and the coil axis Ax about which the first loop part 51a and the second loop part 52a are wound extends in parallel with the first end surface 10c. Therefore, it is possible to improve the Q factor (quality factor) by reducing eddy current loss.

The first lead-out part 51b1 includes the first routing part V1 and the first connection part A1, the first routing part V1 extends from the one end of the first loop part 51a in the direction away from the second coil conductor 52, and the first connection part A1 connects the first routing part V1 and the first external electrode 21. The third lead-out part 51b3 includes the third routing part V3 and the third connection part A3, the third routing part V3 extends from the other end of the first loop part 51a in the direction away from the second coil conductor 52, and the third connection part A3 connects the third routing part V3 and the third external electrode 23. The second lead-out part 52b2 includes the second routing part V2 and the second connection part A2, the second routing part V2 extends from the one end of the second loop part 52a in the direction away from the first coil conductor 51, and the second connection part A2 connects the second routing part V2 and the second external electrode 22. The fourth lead-out part 52b4 includes the fourth routing part V4 and the fourth connection part A4, the fourth routing part V4 extends from the other end of the second loop part 52a in the direction away from the first coil conductor 51, and the fourth connection part A4 connects the fourth routing part V4 and the fourth external electrode 24.

Therefore, the first connection part A1 and the third connection part A3 are located farther from the second coil conductor 52 than the first loop part 51a is, and the second connection part A2 and the fourth connection part A4 are located farther from the first coil conductor 51 than the second loop part 52a is. Therefore, it is possible to locate the first coil conductor 51 and the second coil conductor 52 close to each other without locating the first connection part A1 and third connection part A3, and the second connection part A2 and fourth connection part A4 close to each other. By locating the first coil conductor 51 and the second coil conductor 52 closer to each other, it is possible to improve the coupling coefficient between the first coil conductor 51 and the second coil conductor 52. Further, the shorter the distance between the first connection part A1 and third connection part A3, and the second connection part A2 and fourth connection part A4, the more likely a short circuit through the conductive joining material is to occur during assembling on the assembly substrate 2a. The coil component 100 can avoid such a short circuit.

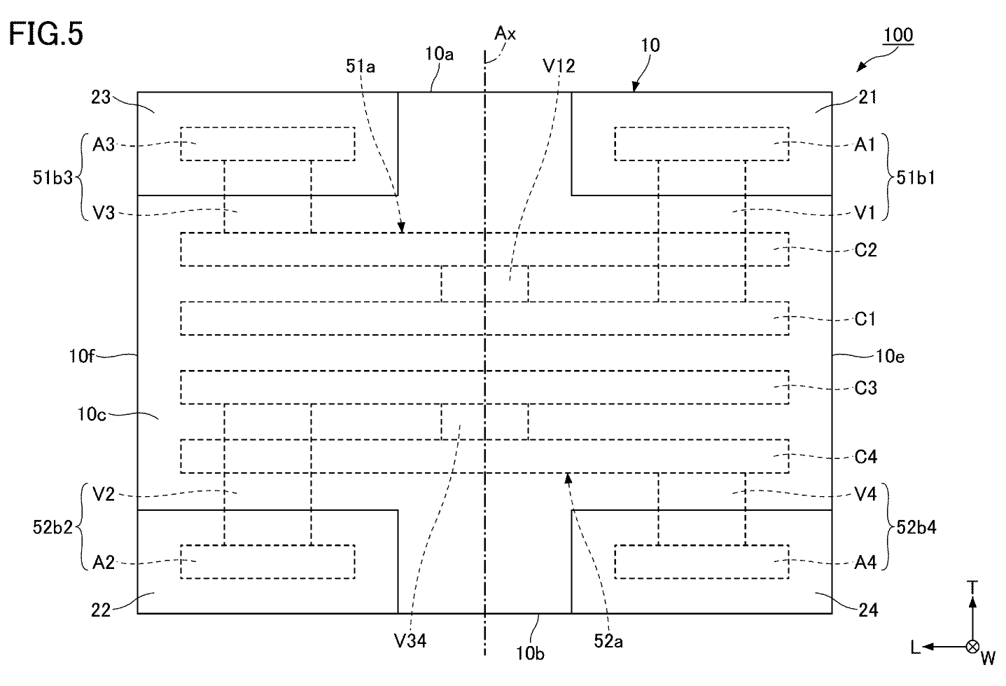

FIG. 5 is a diagram showing a preferred arrangement of the first loop part and the second loop part. As shown in FIG. 5, it is preferable that, in a plan view perpendicular to the first end surface 10c, at least a part of the first loop part 51a and at least a part of the second loop part 52a are located between the first external electrode 21 and third external electrode 23, and the second external electrode 22 and fourth external electrode 24. In this case, it is easier to improve the coupling coefficient while avoiding a short circuit during assembling.

As long as the first connection part A1 and the third connection part A3 are located farther from the second coil conductor 52 than the first loop part 51a is, the shorter the first routing part V1 and the third routing part V3, the more possible it is to reduce the electrical resistance of the first coil conductor 51, and the number of steps involved in the manufacture and the number of magnetic films. Similarly, as long as the second connection part A2 and the fourth connection part A4 are located farther from the first coil conductor 51 than the second loop part 52a is, the shorter the second routing part V2 and the fourth routing part V4, the more possible it is to reduce the electrical resistance of the second coil conductor 52, and the number of steps involved in the manufacture and the number of magnetic films.

As described above, the conductor patterns included in the first loop part 51a or the conductor patterns included in the second loop part 52a are formed in the magnetic films 117 and 116, or the magnetic films 115 and 114. Further, the routing via conductors are formed in the magnetic films 119, 118, 117, 115, 114, and 113. Among these magnetic films, the magnetic films 117, 114, and 115 in which conductor patterns and routing via conductors are formed are examples of first magnetic films, and the magnetic films 119, 118, and 113 in which no conductor patterns are formed and routing via conductors are formed are examples of second magnetic films. It is preferable that the cross-sectional area of the routing via conductors of at least a subset of the second magnetic films (the magnetic films 119, 118, and 113) is larger than the cross-sectional area of the routing via conductors of the first magnetic films (the magnetic films 117, 114, and 115). For example, it is preferable that the cross-sectional areas of the via conductors V1a, V3a, V1b, and V3b are larger than the cross-sectional area of the via conductor V1c, and that the cross-sectional areas of the via conductors V2c and V4b are larger than the cross-sectional areas of the via conductors V2a, V2b, and V4a. In this case, it is possible to reduce the electrical resistance of the first coil conductor 51 and the second coil conductor 52 while avoiding a reduction in the area of the region enclosed by the closed loop track CL, that is, the core area. Note that the cross-sectional area referred to here is an area of a cross-section perpendicular to the T-axis direction in which the routing via conductors extend.

It is preferable that the first lead-out part 51b1 includes a plurality of first connection parts A1, the second lead-out part 52b2 includes a plurality of second connection parts A2, the third lead-out part 51b3 includes a plurality of third connection parts A3, and the fourth lead-out part 52b4 includes a plurality of fourth connection parts A4. In this case as well, it is possible to reduce the electric resistance of the first coil conductor 51 and the second coil conductor 52. For example, the plurality of first connection parts A1 connected to the first routing part V1 may be arranged along the T-axis, the plurality of second connection parts A2 connected to the second routing part V2 may be arranged along the T-axis, the plurality of third connection parts A3 connected to the third routing part V3 may be arranged along the T-axis, and the plurality of fourth connection parts A4 connected to the fourth routing part V4 may be arranged along the T-axis. For example, the coil component 100 may include a plurality of sets of the magnetic films 118 and 119, or a plurality of sets of the magnetic films 113 and 112.

### Second Embodiment

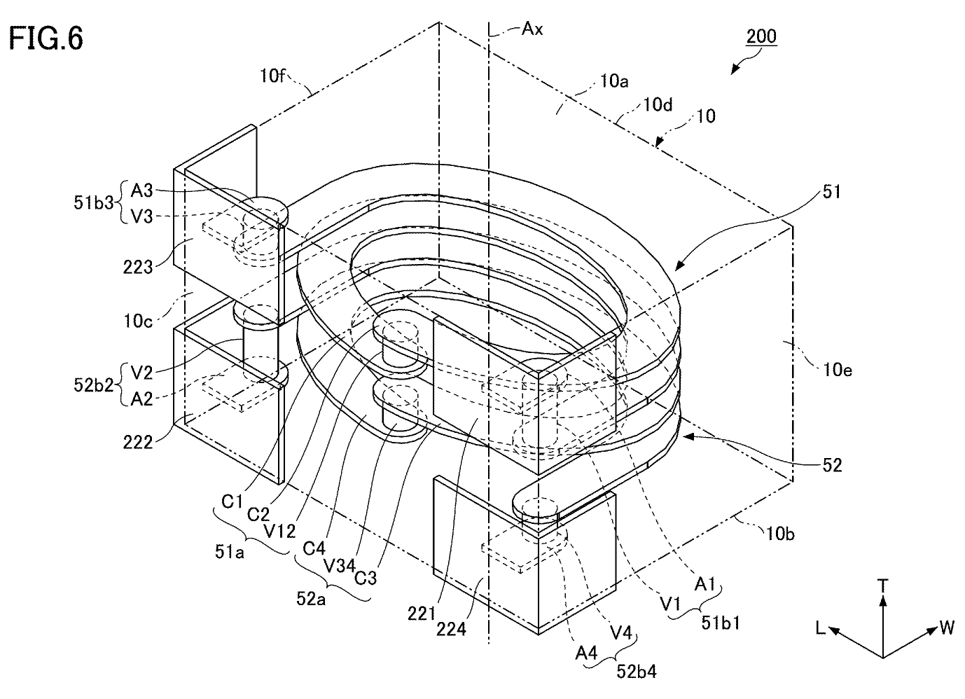

A second embodiment will be described. The second embodiment differs from the first embodiment mainly in the configuration of the external electrodes. FIG. 6 is an oblique view showing a magnetically coupled coil component according to the second embodiment.

As shown in FIG. 6, a magnetically coupled coil component 200 according to the second embodiment includes a first external electrode 221 instead of the first external electrode 21, a second external electrode 222 instead of the second external electrode 22, a third external electrode 223 instead of the third external electrode 23, and a fourth external electrode 224 instead of the fourth external electrode 24. The first external electrode 221 and the fourth external electrode 224 contact not only the first end surface 10c, which is an example of the first surface, but also the first side surface 10e, which is an example of the second surface. The second external electrode 222 and the third external electrode 223 contact not only the first end surface 10c, which is an example of the first surface, but also the second side surface 10f, which is an example of the third surface.

Other configurational particulars of the second embodiment are the same as those of the first embodiment. According to also the second embodiment, the same effects as those of the first embodiment can be obtained. In addition, according to the second embodiment, during assembling on the assembly substrate 2a, a fillet of a conductive joining material, such as solder and the like, can be formed to face the first side surface 10e and the second side surface 10f, which makes it possible to improve the assembling strength on the assembly substrate 2a.

The first connection part A1 may include a part that is exposed to the first side surface 10e and is in contact with the first external electrode 221, and the second connection part A2 may include a part that is exposed to the second side surface 10f and is in contact with the second external electrode 222. The third connection part A3 may include a part that is exposed to the second side surface 10f and is in contact with the third external electrode 223, and the fourth connection part A4 may include a part that is exposed to the first side surface 10e and is in contact with the fourth external electrode 224.

### Third Embodiment

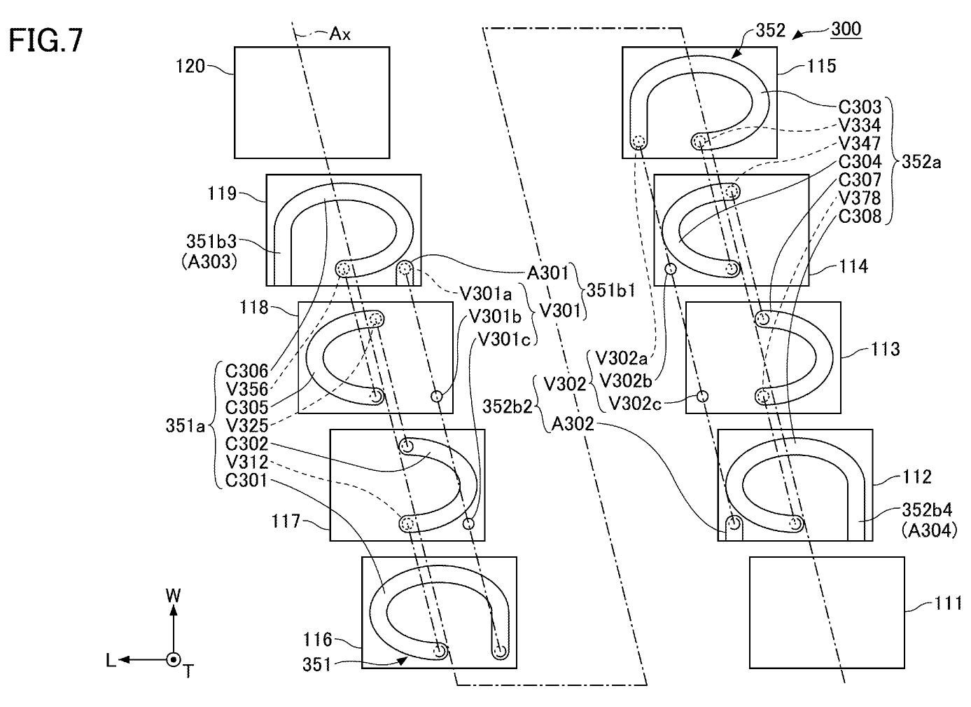

A third embodiment will be described. The third embodiment differs from the first embodiment mainly in the configuration of the coil conductors. FIG. 7 is an exploded view showing a magnetically coupled coil component according to the third embodiment. In FIG. 7, external electrodes are omitted for convenience of explanation.

As shown in FIG. 7, a magnetically coupled coil component 300 according to the third embodiment includes a first coil conductor 351 instead of the first coil conductor 51, and a second coil conductor 352 instead of the second coil conductor 52.

The first coil conductor 351 includes a first loop part 351a, a first lead-out part 351b1, and a third lead-out part 351b3. The second coil conductor 352 includes a second loop part 352a, a second lead-out part 352b2, and a fourth lead-out part 352b4. The first loop part 351a and the second loop part 352a extend in the circumferential direction about a coil axis Ax extending along the T-axis direction. That is, the first loop part 351a and the second loop part 352a are wound around the coil axis Ax extending in the direction parallel with the first end surface 10c. The first lead-out part 351b1 is connected to one end of the first loop part 351a. The third lead-out part 351b3 is connected to the other end of the first loop part 351a. The second lead-out part 352b2 is connected to one end of the second loop part 352a. The fourth lead-out part 352b4 is connected to the other end of the second loop part 352a.

The first lead-out part 351b1 is connected to the first external electrode 21. The second lead-out part 352b2 is connected to the second external electrode 22. The third lead-out part 351b3 is connected to the third external electrode 23. The fourth lead-out part 352b4 is connected to the fourth external electrode 24.

An eighth conductor pattern C308, and a second connection part A302 and a fourth connection part A304, which are conductor patterns, are formed on the upper surface of the magnetic film 112. A seventh conductor pattern C307 is formed on the upper surface of the magnetic film 113, a fourth conductor pattern C304 is formed on the upper surface of the magnetic film 114, and a third conductor pattern C303 is formed on the upper surface of the magnetic film 115. A first conductor pattern C301 is formed on the upper surface of the magnetic film 116, a second conductor pattern C302 is formed on the upper surface of the magnetic film 117, and a fifth conductor pattern C305 is formed on the upper surface of the magnetic film 118. A sixth conductor pattern C306, and a first connection part A301 and a third connection part A303, which are conductor patterns, are formed on the upper surface of the magnetic film 119. All of the first conductor pattern C301, the second conductor pattern C302, the third conductor pattern C303, the fourth conductor pattern C304, the fifth conductor pattern C305, the sixth conductor pattern C306, the seventh conductor pattern C307, and the eighth conductor pattern C308 extend in the circumferential direction about the coil axis Ax. The first connection part A301, the second connection part A302, the third connection part A303, and the fourth connection part A304 are exposed from the substrate 10 on the first end surface 10c.

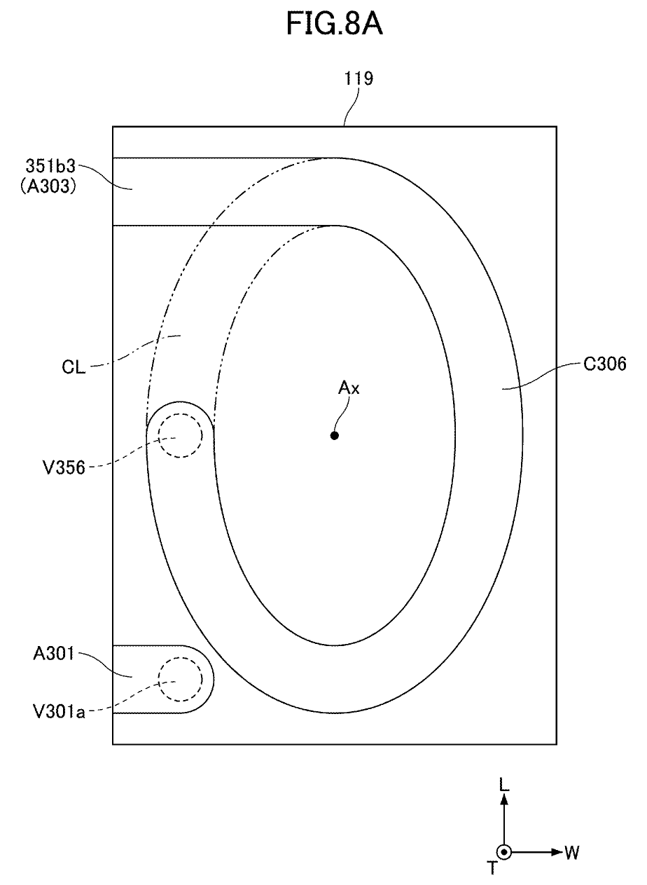

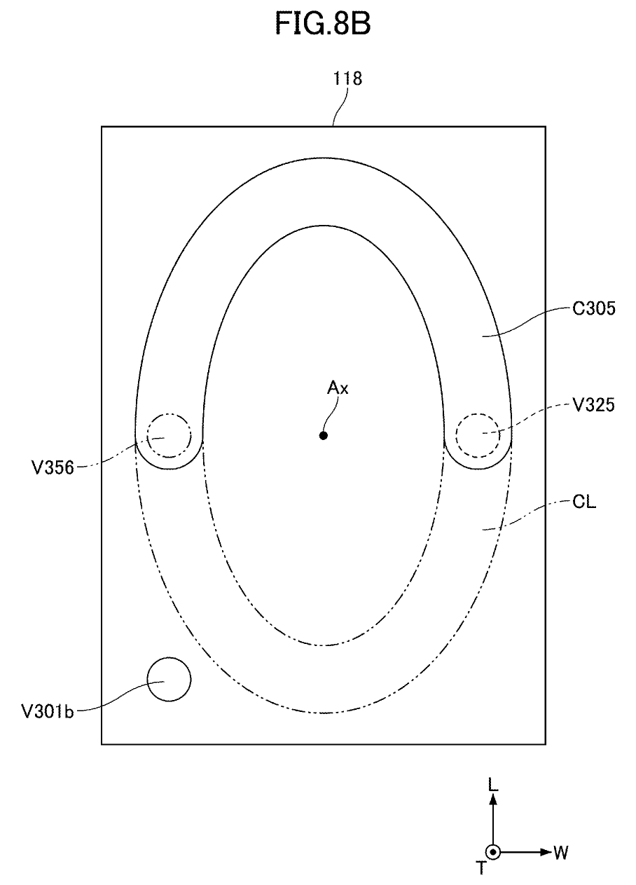

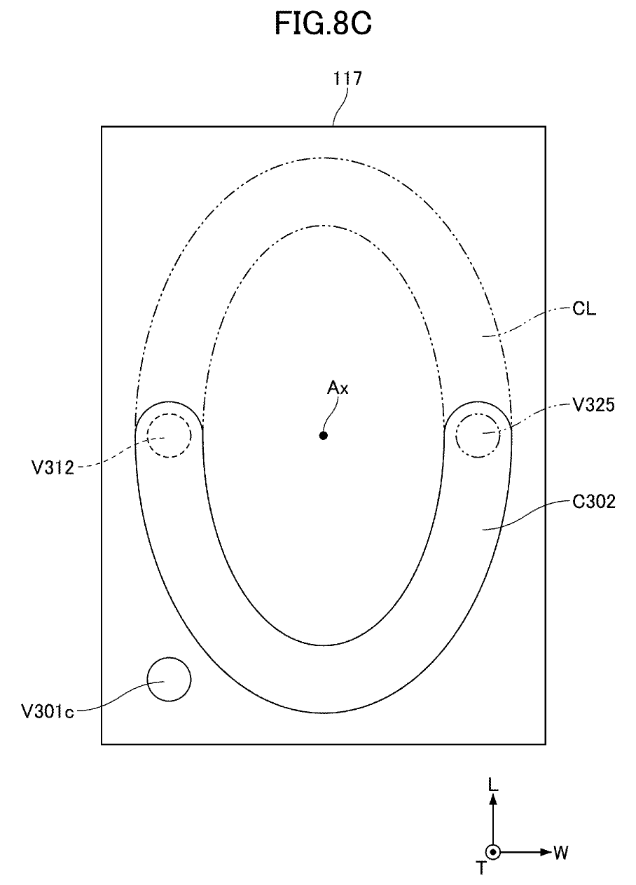

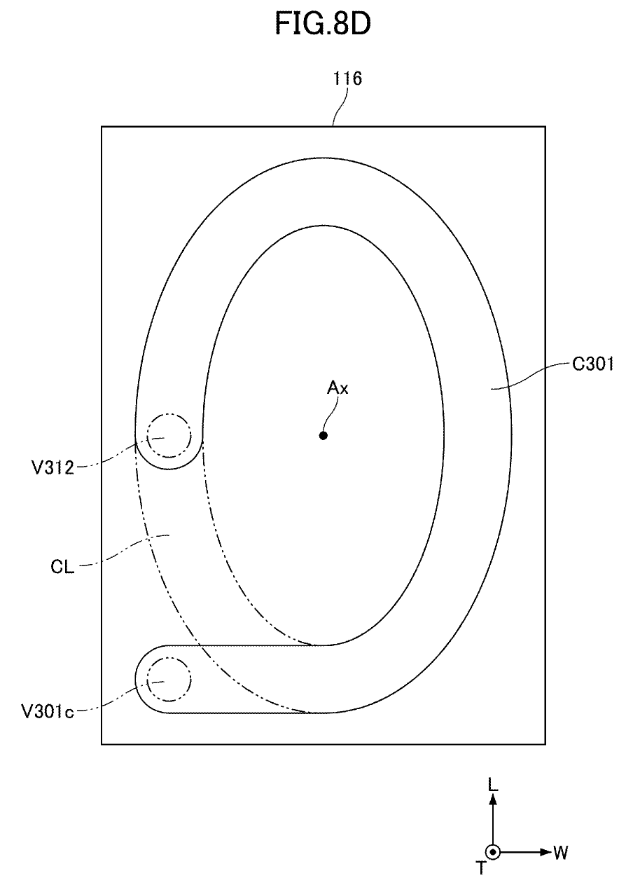

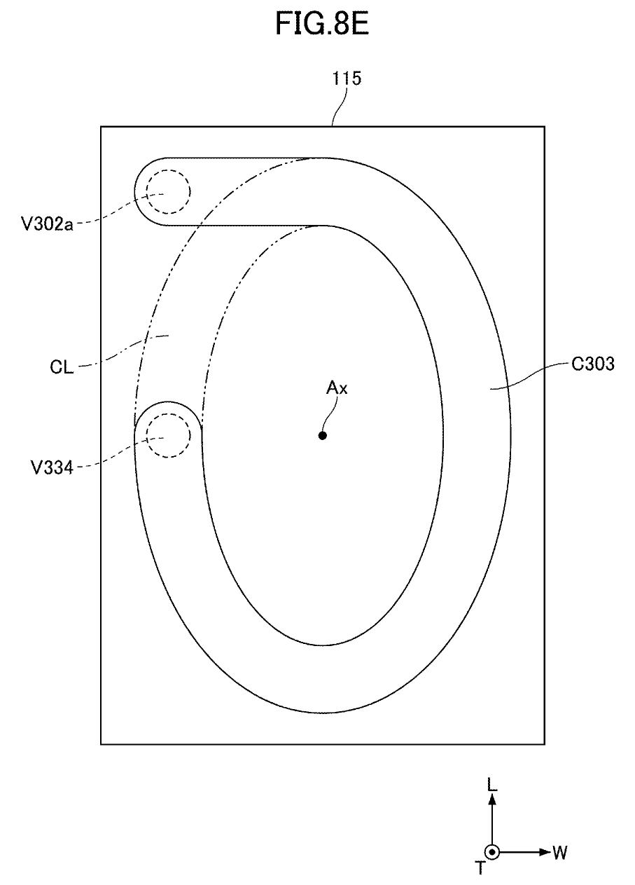

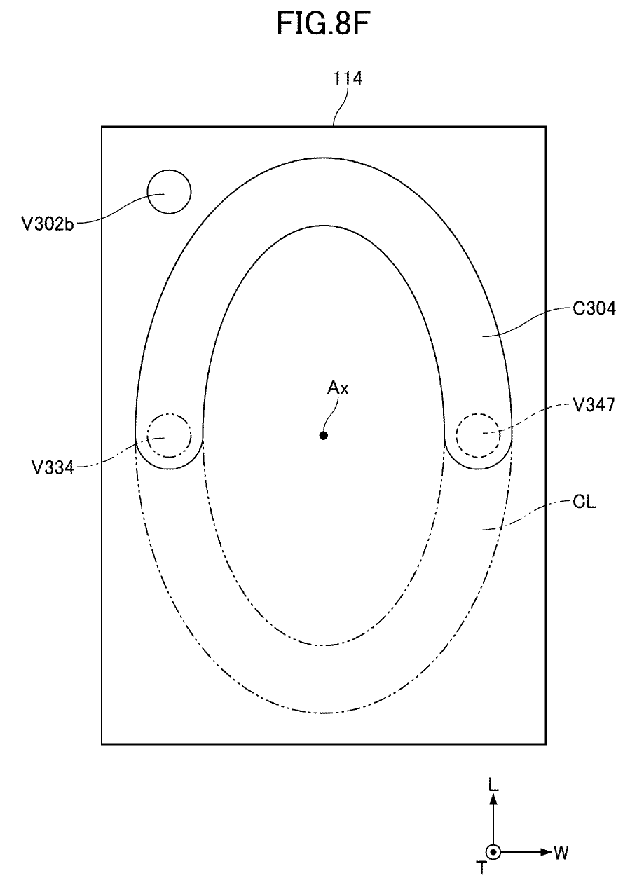

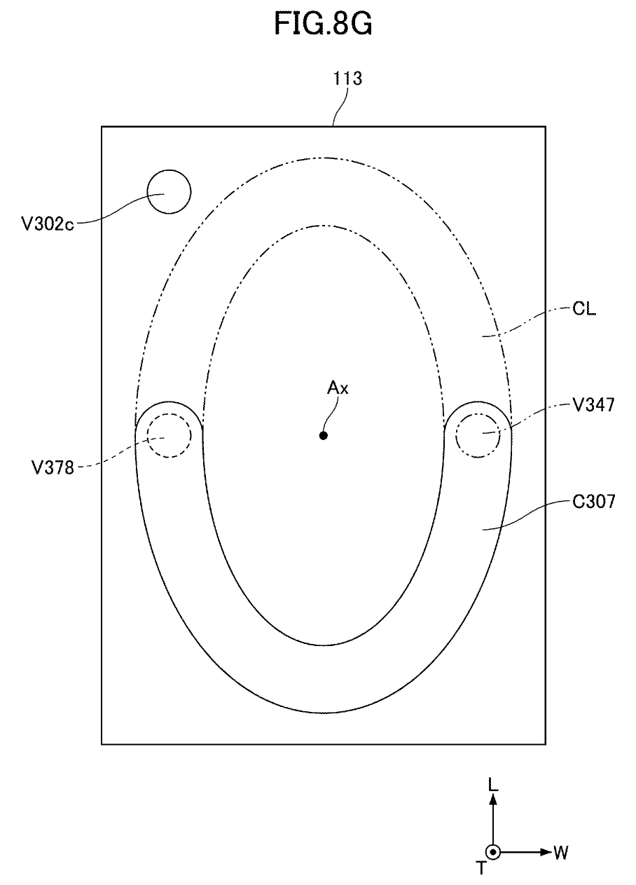

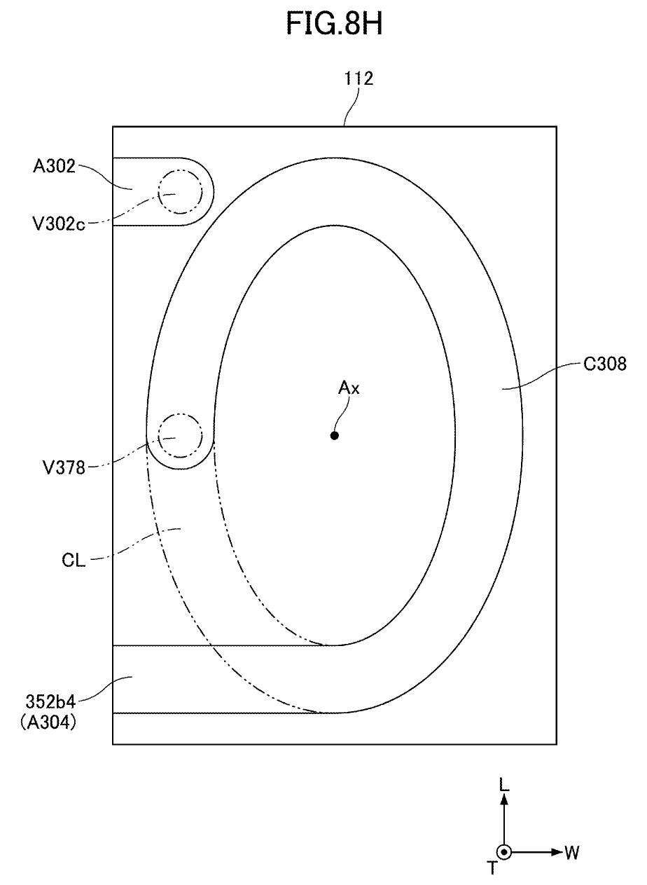

The conductor patterns and the via conductors of the coil component 300 will be further described. FIGS. 8A, 8B, 8C, 8D, 8E, 8F, 8G, and 8H are plan views showing the magnetic films 119, 118, 117, 116, 115, 114, 113, and 112, respectively.

As shown in FIGS. 7 and 8A, the sixth conductor pattern C306, the first connection part A301, and the third connection part A303 are formed on the upper surface of the magnetic film 119. The sixth conductor pattern C306 extends in the circumferential direction about the coil axis Ax in a plane (LW plane) orthogonal to the coil axis Ax by a number of turns that is less than one turn. The sixth conductor pattern C306 extends by approximately 0.75 turns (270°) in the circumferential direction about the coil axis Ax. One end of the sixth conductor pattern C306 is connected to the third connection part A303. Further, a through-hole penetrating the magnetic film 119 in the T-axis direction is provided in a region of the magnetic film 119 overlapping the other end of the sixth conductor pattern C306, and a via conductor V356 is embedded in the through-hole. Further, a through-hole penetrating the magnetic film 119 in the T-axis direction is provided in a region of the magnetic film 119 overlapping the first connection part A301, and a via conductor V301a is embedded in the through-hole.

As shown in FIGS. 7 and 8B, the fifth conductor pattern C305 is formed on the upper surface of the magnetic film 118. The fifth conductor pattern C305 extends in the circumferential direction about the coil axis Ax in a plane (LW plane) orthogonal to the coil axis Ax by a number of turns that is less than one turn. The fifth conductor pattern C305 extends in the circumferential direction about the coil axis Ax by approximately 0.5 turns (180°). One end of the fifth conductor pattern C305 is connected to the via conductor V356. Further, a through-hole penetrating the magnetic film 118 in the T-axis direction is provided in a region of the magnetic film 118 overlapping the other end of the fifth conductor pattern C305, and a via conductor V325 is embedded in the through-hole. Further, a through-hole penetrating the magnetic film 118 in the T-axis direction is provided in a region of the magnetic film 118 overlapping the via conductor V301a in a plan view, and a via conductor V301b is embedded in the through-hole. The via conductor V301b is connected to the via conductor V301a.

As shown in FIGS. 7 and 8C, the second conductor pattern C302 is formed on the upper surface of the magnetic film 117. The second conductor pattern C302 extends in the circumferential direction about the coil axis Ax in a plane (LW plane) orthogonal to the coil axis Ax by a number of turns that is less than one turn. The second conductor pattern C302 extends by approximately 0.5 turns (180°) in the circumferential direction about the coil axis Ax. One end of the second conductor pattern C302 is connected to the via conductor V325. Further, a through-hole penetrating the magnetic film 117 in the T-axis direction is provided in a region of the magnetic film 117 overlapping the other end of the second conductor pattern C302, and a via conductor V312 is embedded in the through-hole. Further, a through-hole penetrating the magnetic film 117 in the T-axis direction is provided in a region of the magnetic film 117 overlapping the via conductor V301b in a plan view, and a via conductor V301c is embedded in the through-hole. The via conductor V301c is connected to the via conductor V301b.

As shown in FIGS. 7 and 8D, the first conductor pattern C301 is formed on the upper surface of the magnetic film 116. The first conductor pattern C301 extends in the circumferential direction about the coil axis Ax in a plane (LW plane) orthogonal to the coil axis Ax by a number of turns that is less than one turn. The first conductor pattern C301 extends in the circumferential direction about the coil axis Ax by approximately 0.75 turns (270°). One end of the first conductor pattern C301 is connected to the via conductor V312. The other end of the first conductor pattern C301 is connected to the via conductor V301c.

As shown in FIGS. 7 and 8E, the third conductor pattern C303 is formed on the upper surface of the magnetic film 115. The third conductor pattern C303 has a shape that is linearly symmetrical with the first conductor pattern C301 with respect to an axial line that intersects the coil axis Ax and extends along the W-axis as the axis of symmetry. A through-hole penetrating the magnetic film 115 in the T-axis direction is provided in a region of the magnetic film 115 overlapping one end of the third conductor pattern C303, and a via conductor V302a is embedded in the through-hole. A through-hole penetrating the magnetic film 115 in the T-axis direction is provided in a region of the magnetic film 115 overlapping the other end of the third conductor pattern C303, and a via conductor V334 is embedded in the through-hole.

As shown in FIGS. 7 and 8F, the fourth conductor pattern C304 is formed on the upper surface of the magnetic film 114. The fourth conductor pattern C304 has a shape that is linearly symmetrical with the second conductor pattern C302 with respect to an axial line that intersects the coil axis Ax and extends along the W-axis as the axis of symmetry. One end of the fourth conductor pattern C304 is connected to the via conductor V334. Further, a through-hole penetrating the magnetic film 114 in the T-axis direction is provided in a region overlapping the other end portion of the fourth conductor pattern C304, and a via conductor V347 is embedded in the through-hole. Further, a through-hole penetrating the magnetic film 114 in the T-axis direction is provided in a region of the magnetic film 114 overlapping the via conductor V302a in a plan view, and a via conductor V302b is embedded in the through-hole. The via conductor V302b is connected to the via conductor V302a.

As shown in FIGS. 7 and 8G, the seventh conductor pattern C307 is formed on the upper surface of the magnetic film 113. The seventh conductor pattern C307 has a shape that is linearly symmetrical with the fifth conductor pattern C305 with respect to an axial line that intersects the coil axis Ax and extends along the W-axis as the axis of symmetry. One end of the seventh conductor pattern C307 is connected to the via conductor V347. A through-hole penetrating the magnetic film 113 in the T-axis direction is provided in a region overlapping the other end of the seventh conductor pattern C307, and a via conductor V378 is embedded in the through-hole. A through-hole penetrating the magnetic film 113 in the T-axis direction is provided in a region of the magnetic film 113 overlapping the via conductor V302b in a plan view, and a via conductor V302c is embedded in the through-hole. The via conductor V302c is connected to the via conductor V302b.

As shown in FIGS. 7 and 8H, the eighth conductor pattern C308, the second connection part A302, and the fourth connection part A304 are formed on the upper surface of the magnetic film 112. The eighth conductor pattern C308 has a shape that is linearly symmetrical with the sixth conductor pattern C306 with respect to an axial line that intersects the coil axis Ax and extends along the W-axis as the axis of symmetry. One end of the eighth conductor pattern C308 is connected to the via conductor V378. The other end of the eighth conductor pattern C308 is connected to the fourth connection part A304. The second connection part A302 is formed in a region overlapping the via conductor V302c in a plan view and is connected to the via conductor V302c.

In this way, the first conductor pattern C301 and the second conductor pattern C302 are connected in series via the via conductor V312, the second conductor pattern C302 and the fifth conductor pattern C305 are connected in series via the via conductor V325, and the fifth conductor pattern C305 and the sixth conductor pattern C306 are connected in series via the via conductor V356. The first conductor pattern C301, the via conductor V312, the second conductor pattern C302, the via conductor V325, the fifth conductor pattern C305, the via conductor V356, and the sixth conductor pattern C306 constitute the first loop part 351a having a spiral shape that extends around the coil axis Ax by approximately 2.5 turns in the substrate 10. The third conductor pattern C303 and the fourth conductor pattern C304 are connected in series via the via conductor V334, the fourth conductor pattern C304 and the seventh conductor pattern C307 are connected in series via the via conductor V347, and the seventh conductor pattern C307 and the eighth conductor pattern C308 are connected in series via the via conductor V378. The third conductor pattern C303, the via conductor V334, the fourth conductor pattern C304, the via conductor V347, the seventh conductor pattern C307, the via conductor V378, and the eighth conductor pattern C308 constitute the second loop part 352a having a spiral shape that extends around the coil axis Ax by approximately 2.5 turns in the substrate 10.

The first lead-out part 351b1 includes a first routing part V301 and the first connection part A301. The first routing part V301 includes the via conductors V301a, V301b, and V301c arranged on the same axial line extending in parallel with the T-axis, and extends from one end of the first loop part 351a in a direction away from the second coil conductor 352 (in the positive direction on the T-axis). The first connection part A301 connects the first routing part V301 and the first external electrode 21. That is, the one end of the first loop part 351a is connected to the first external electrode 21 via the first lead-out part 351b1. The via conductors V301a, V301b, and V301c are examples of routing via conductors.

The third lead-out part 351b3 includes the third connection part A303 and connects the first loop part 351a and the third external electrode 23. That is, the other end of the first loop part 351a is connected to the third external electrode 23 via the third lead-out part 351b3.

The second lead-out part 352b2 includes a second routing part V302 and the second connection part A302. The second routing part V302 includes the via conductors V302a, V302b and V302c arranged on the same axial line extending in parallel with the T-axis, and extends from one end of the second loop part 352a in a direction away from the first coil conductor 351 (in the negative direction on the T-axis). The second connection part A302 connects the second routing part V302 and the second external electrode 22. That is, the one end of the second loop part 352a is connected to the second external electrode 22 via the second lead-out part 352b2. The via conductors V302a, V302b and V302c are examples of routing via conductors.

The fourth lead-out part 352b4 includes the fourth connection part A304, and connects the second loop part 352a and the fourth external electrode 24. That is, the other end of the second loop part 352a is connected to the fourth external electrode 24 via the fourth lead-out part 352b4.

Other configurational particulars of the third embodiment are the same as those of the first embodiment.

Similarly to the first embodiment, the coil component 300 according to the third embodiment can reduce eddy current loss and improve the Q factor (quality factor).

In the coil component 300, the first connection part A301 and the third connection part A303 are located farther from the second coil conductor 352 than a part of the first loop part 351a is, and the second connection part A302 and the fourth connection part A304 are located farther from the first coil conductor 351 than a part of the second loop part 352a. Therefore, it is possible to locate a part of the first coil conductor 351 and a part of the second coil conductor 352 close to each other without locating the first connection part A301 and third connection part A303, and the second connection part A302 and fourth connection part A304 close to each other. By locating a part of the first coil conductor 351 and a part of the second coil conductor 352 close to each other, it is possible to improve the coupling coefficient between the first coil conductor 351 and the second coil conductor 352. Further, the shorter the distance between the first connection part A301 and third connection part A303, and the second connection part A302 and fourth connection part A304, the more likely a short circuit through the conductive joining material is to occur during assembling on the assembly substrate 2a. The coil component 300 can avoid such a short circuit.

In this specification and the like, the indications “first”, “second”, “third”, and the like are used to identify the components, and do not necessarily limit the number, order, or contents of the components. Further, numerals for identifying the components are used for each context, and numerals used in one context do not necessarily indicate the same components in other contexts. Further, a component identified by a certain numeral is not precluded from serving the function of a component identified by another numeral.

Aspects of the present disclosure are, for example, as follows.

### <1>

A magnetically coupled coil component, including:
a magnetic substrate having a first surface;
a first coil conductor provided in the magnetic substrate, and including a first loop part wound around a coil axis extending in a direction parallel with the first surface, a first lead-out part connected to one end of the first loop part, and a third lead-out part connected to the other end of the first loop part;
a second coil conductor provided in the magnetic substrate, and including a second loop part wound around the coil axis, a second lead-out part connected to one end of the second loop part, and a fourth lead-out part connected to the other end of the second loop part;
a first external electrode provided on the magnetic substrate to contact at least the first surface, and connected to the first lead-out part;
a second external electrode provided on the magnetic substrate to contact at least the first surface, and connected to the second lead-out part;
a third external electrode provided on the magnetic substrate to contact at least the first surface, and connected to the third lead-out part; and
a fourth external electrode provided on the magnetic substrate to contact at least the first surface, and connected to the fourth lead-out part,
wherein the first lead-out part includes:
   a first routing part extending from the one end of the first loop part in a direction away from the second coil conductor; and
   a first connection part connecting the first routing part and the first external electrode, and the second lead-out part includes:
      a second routing part extending from the one end of the second loop part in a direction away from the first coil conductor; and
      a second connection part connecting the second routing part and the second external electrode.

### <2>

The magnetically coupled coil component according to <1>,

wherein the third lead-out part includes:
a third routing part extending from the other end of the first loop part in the direction away from the second coil conductor; and
a third connection part connecting the third routing part and the third external electrode, and
the fourth lead-out part includes:
   a fourth routing part extending from the other end of the second loop part in the direction away from the first coil conductor; and
   a fourth connection part connecting the fourth routing part and the fourth external electrode.

### <3>

The magnetically coupled coil component according to <2>,
wherein the third lead-out part includes a plurality of third connection parts, each of which is the third connection part, and
the fourth lead-out part includes a plurality of fourth connection parts, each of which is the fourth connection part.

### <4>

The magnetically coupled coil component according to <2> or <3>,
wherein the magnetic substrate includes a plurality of magnetic films laminated along the coil axis,
a conductor pattern included in the first loop part or a conductor pattern included in the second loop part is formed on a subset of the plurality of magnetic films,
each of the first routing part, the second routing part, the third routing part, and the fourth routing part is formed by routing via conductors that are formed on a subset of the plurality of magnetic films being joined with each other, the conductor pattern and the routing via conductor are formed on one, or two or more first magnetic films, which are a subset of the plurality of magnetic films,
the conductor pattern is not formed and the routing via conductor is formed on one, or two or more second magnetic films, which are another subset of the plurality of magnetic films, and a cross-sectional area of the routing via conductor of at least a subset of the one, or two or more second magnetic films is larger than a cross-sectional area of the routing via conductor of the first magnetic films.

### <5>

The magnetically coupled coil component according to any one of <1> to <4>,
wherein, in a plan view perpendicular to the first surface, at least a part of the first loop part and at least a part of the second loop part are located between the first external electrode and third external electrode, and the second external electrode and fourth external electrode.

### <6>

The magnetically coupled coil component according to any one of <1> to <5>,

wherein the magnetic substrate has:
a second surface perpendicular to the first surface and parallel with the coil axis; and
a third surface opposite to the second surface, the first external electrode and the fourth external electrode contact also the second surface, and
the second external electrode and the third external electrode contact also the third surface.

### <7>

The magnetically coupled coil component according to any one of <1> to <6>,
wherein the first lead-out part includes a plurality of first connection parts, each of which is the first connection part, and
the second lead-out part includes a plurality of second connection parts, each of which is the second connection part.

What is claimed is:

1. A magnetically coupled coil component, comprising:
a magnetic substrate having a first surface;
a first coil conductor provided in the magnetic substrate, and including a first loop part wound around a coil axis extending in a direction parallel with the first surface, a first lead-out part connected to one end of the first loop part, and a third lead-out part connected to the other end of the first loop part;
a second coil conductor provided in the magnetic substrate, and including a second loop part wound around the coil axis, a second lead-out part connected to one end of the second loop part, and a fourth lead-out part connected to the other end of the second loop part;
a first external electrode provided on the magnetic substrate to contact at least the first surface, and connected to the first lead-out part;
a second external electrode provided on the magnetic substrate to contact at least the first surface, and connected to the second lead-out part;
a third external electrode provided on the magnetic substrate to contact at least the first surface, and connected to the third lead-out part; and
a fourth external electrode provided on the magnetic substrate to contact at least the first surface, and connected to the fourth lead-out part,
wherein the first lead-out part includes:
a first routing part extending from the one end of the first loop part in a direction away from the second coil conductor; and
a first connection part connecting the first routing part and the first external electrode, and
the second lead-out part includes:
a second routing part extending from the one end of the second loop part in a direction away from the first coil conductor; and
a second connection part connecting the second routing part and the second external electrode.

2. The magnetically coupled coil component according to claim 1,
wherein the third lead-out part includes:
a third routing part extending from the other end of the first loop part in the direction away from the second coil conductor; and
a third connection part connecting the third routing part and the third external electrode, and
the fourth lead-out part includes:
a fourth routing part extending from the other end of the second loop part in the direction away from the first coil conductor; and
a fourth connection part connecting the fourth routing part and the fourth external electrode.

3. The magnetically coupled coil component according to claim 2,
wherein the third lead-out part includes a plurality of third connection parts, each of which is the third connection part, and
the fourth lead-out part includes a plurality of fourth connection parts, each of which is the fourth connection part.

4. The magnetically coupled coil component according to claim 2,
wherein the magnetic substrate includes a plurality of magnetic films laminated along the coil axis,
a conductor pattern included in the first loop part or a conductor pattern included in the second loop part is formed on a subset of the plurality of magnetic films,
each of the first routing part, the second routing part, the third routing part, and the fourth routing part is formed by routing via conductors that are formed on a subset of the plurality of magnetic films being joined with each other,
the conductor pattern and the routing via conductor are formed on one, or two or more first magnetic films, which are a subset of the plurality of magnetic films,
the conductor pattern is not formed and the routing via conductor is formed on one, or two or more second magnetic films, which are another subset of the plurality of magnetic films, and
a cross-sectional area of the routing via conductor of at least a subset of the one, or two or more second magnetic films is larger than a cross-sectional area of the routing via conductor of the first magnetic film.

5. The magnetically coupled coil component according to claim 1,
wherein, in a plan view perpendicular to the first surface, at least a part of the first loop part and at least a part of the second loop part are located between the first external electrode and third external electrode, and the second external electrode and fourth external electrode.

6. The magnetically coupled coil component according to claim 1,
wherein the magnetic substrate has:
a second surface perpendicular to the first surface and parallel with the coil axis; and
a third surface opposite to the second surface,
the first external electrode and the fourth external electrode contact also the second surface, and
the second external electrode and the third external electrode contact also the third surface.

7. The magnetically coupled coil component according to claim 1,
wherein the first lead-out part includes a plurality of first connection parts, each of which is the first connection part, and
the second lead-out part includes a plurality of second connection parts, each of which is the second connection part.
